(19) United States
(12) Patent Application Publication
(10) Pub. No.: US 2025/0101781 A1
(43) Pub. Date: Mar. 27, 2025

(54) Ice Break Emergency Release

(71) Applicant: Illinois Tool Works Inc., Glenview, IL (US)

(72) Inventor: Justin Ruzich, Frankfort, IL (US)

(21) Appl. No.: 18/828,526

(22) Filed: Sep. 9, 2024

Related U.S. Application Data
(60) Provisional application No. 63/539,893, filed on Sep. 22, 2023.

(51) Int. Cl. E05C 19/02; E05B 81/90; E05B 83/34

(52) U.S. Cl. CPC E05C 19/02; E05B 81/90; E05B 83/34

(57) ABSTRACT

The present disclosure relates to an actuating assembly for a vehicle, configured to control the movement of a cover assembly that selectively covers a compartment, such as a charging, fueling, or service compartment. The actuating assembly includes a drive assembly, a drive train, and a locking mechanism to secure the cover assembly in a closed position. In the event of an obstruction, such as ice accumulation, the mechanism features a manual override system comprising a handle and cable that allows the user to disengage the locking mechanism and manually open the cover.

### RELATED APPLICATION

The present application claims priority to U.S. Provisional Patent Application No. 63/539,893, filed Sep. 22, 2023, and entitled “Ice Break Emergency Release,” which is hereby incorporated by reference in its entirety.

### BACKGROUND

Hybrid and electric vehicles typically feature a traction battery, which can be charged through an external electrical connector accessible on the vehicle body. For plug-in hybrid electric vehicles (PHEVs) and battery electric vehicles (BEVs), this connector-commonly referred to as a charging port-enables connection to an external charging station or a standard electrical outlet. The charging port is housed within a charging/fueling compartment on the vehicle body, which is covered by a charging flap or closure element. A mechanism associated with this charging flap allows the compartment to be selectively opened or closed, providing access to the charging port. In combustion engine vehicles, fuel is supplied to the fuel tank through a filler neck, which is similarly accessible from the outside of the vehicle by connecting to a fuel pump or nozzle. The filler neck is typically enclosed within a housing that is covered by a fueling flap or closure element. As with the charging port, a mechanism allows the fueling compartment to be opened or closed, granting access to the filler neck.

Actuating assemblies and apparatuses for opening and closing covers on vehicles are well-known in the prior art (e.g., U.S. Pat. No. 8,353,553B2, U.S. Pat. No. 8,585,119B2, U.S. Pat. No. 9,631,403B2, U.S. Pat. No. 9,616,745B2). However, there remains a need for systems that can coordinate multiple functions within charging, fueling, or service compartments. These functions include unlocking and locking the flap, moving the flap between open and closed positions, and controlling additional features such as lighting within the compartment. Commonly-owned U.S. Patent Pub. No. 2023/0151651 to Hegwein describes A locking device enables locking a charging, fueling, or service flap on a compartment. The flap is reversibly movable between a closed position and an open position.

The various functions should be coordinate and/or synchronized. For example, during charging, the flap must first be unlocked before it can be moved to the open position, allowing access to the charging port. Only after the charging connector is properly engaged can the flap be locked again.

To achieve this coordination, multiple actuators are typically employed within the compartment system, with each actuator responsible for a specific function (e.g., unlocking the flap or moving it). A control device is used to manage and synchronize the operation of these actuators. However, such systems are exposed to varying weather conditions, which can lead to sealing issues. For instance, components like the flap may become iced over, hindering their operation. Nevertheless, despite existing advancements, a need exists for an actuating assembly with an override assembly.

### SUMMARY

The present disclosure relates generally to an actuating assembly, substantially as illustrated by and described in connection with at least one of the figures, as set forth more completely in the claims. For example, the present disclosure relates generally to an actuating assembly with an override assembly to release a cover assembly if it becomes stuck, for example, due to icing.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIGS. 1a and 1b illustrate, respectively, perspective views of an actuating assembly in accordance with an aspect of the subject disclosure in closed and open positions.

FIG. 1c illustrates a side view of the actuating assembly in the closed position.

FIG. 1d illustrates a cross-sectional side view of the actuating assembly along cut line A-A.

FIG. 2a illustrates a detailed schematic view of the drive train with the gear assembly in a locked state.

FIG. 2b illustrates a detailed schematic view of the drive train with the gear assembly in an unlocked state.

FIG. 2c illustrates a detailed schematic view of the actuating assembly having a powered override actuator in accordance with another aspect of the present disclosure.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure generally pertains to locking devices for securing covers on or within a housing, particularly on a vehicle body. Specifically, it focuses on locking mechanisms configured to actuate covers-such as charging, fueling, or service flaps-within a charging, fueling, or service compartment that is integrated into a vehicle body component. Additionally, the disclosure relates to a system comprising a cover (specifically in the form of a charging, fueling, or service flap) and a corresponding charging, fueling, or service compartment, which is integrated or can be integrated into a vehicle body component. The cover is configured to move reversibly between a closed and an open position relative to the compartment, and a locking device is provided to secure the cover in place. Finally, the disclosure also encompasses a vehicle equipped with such a system. The terms “fueling flap” and “fueling compartment” as used in this disclosure extend beyond components specific to a fuel tank. These terms also encompass components associated with tanks for other resources, such as AdBlue (urea) or additives like water. Accordingly, the disclosure includes actuating assemblies for service flaps related to filling systems for various tanks, including those for fuel, AdBlue, or water.

In one example, a drive assembly to move a cover assembly of a vehicle relative to a housing between an open position and a closed position, comprises: a drive pinion configured to receive a drive shaft; a cam pinion meshed with the drive pinion, wherein the drive pinion is configured to rotate the cam pinion; a gear-rack cam having a first end and a second end, wherein the second end is meshed with the cam pinion, and wherein the gear-rack cam is configured to translate in response to rotation of the cam pinion; and a flap lock configured to pivot relative to the housing between a locked state and an unlocked state, wherein the flap lock is pivotally connected to the second end of the gear-rack cam via a pivot connection; and an override assembly operably coupled to the second end of the gear-rack cam and configured to translate the gear-rack cam to move the flap lock from the locked state to the unlocked state.

In another example, an actuating assembly for a cover assembly of a vehicle, the actuating assembly comprises: a housing having a compartment; a drive assembly coupled to the housing, wherein the drive assembly comprises a drive train that is configured to move the cover assembly relative to the housing between an open position and a closed position, and wherein the drive assembly is configured to secure the cover assembly in a locked state to cover the compartment; and an override assembly operably coupled to the drive train and configured to move the cover assembly from the locked state to an unlocked state.

In some examples, the override assembly comprises a handle and a cable, wherein the cable is coupled to the handle and to the second end of the gear-rack cam.

In some examples, manipulation of the handle actuates the cable to move the flap lock from the closed position to the open position.

In some examples, the cable comprises a wire and an outer sheath, the wire being slidable within the outer sheath to transmit force between the handle and the second end of the gear-rack cam.

In some examples, the drive assembly further comprises a powered override actuator configured to pull the second end of the gear-rack cam via a cable or portion thereof in response to a control signal to thereby move the flap lock from the locked state to the unlocked state.

In some examples, the powered override actuator includes an electric motor.

In some examples, the handle is a pull loop.

In some examples, the outer sheath comprises: an inner lining; a longitudinally incompressible layer; and a protective outer covering.

In some examples, the drive train comprises a cover linkage assembly that is configured to secure the cover assembly in the locked state and a gear assembly that is operably connected to the cover linkage assembly.

In some examples, the gear assembly comprises: a drive pinion configured to receive a drive shaft; and a cam pinion meshed with the drive pinion.

In some examples, the cover linkage assembly comprises a flap lock and a gear-rack cam having a first end and a second end, wherein the flap lock is pivotally connected to the second end of the gear-rack cam via a pivot connection and is configured to pivot about an axis relative to the housing.

In some examples, the gear-rack cam is configured to mesh with the cam pinion, the gear-rack cam being configured to translate in response to rotation of the cam pinion.

In some examples, the flap lock is configured to pivot about an axis in response to translation of the gear-rack cam, the flap lock moving between the locked state and the unlocked state.

In some examples, the compartment is: a charging compartment; a fueling compartment; or a service compartment of the vehicle.

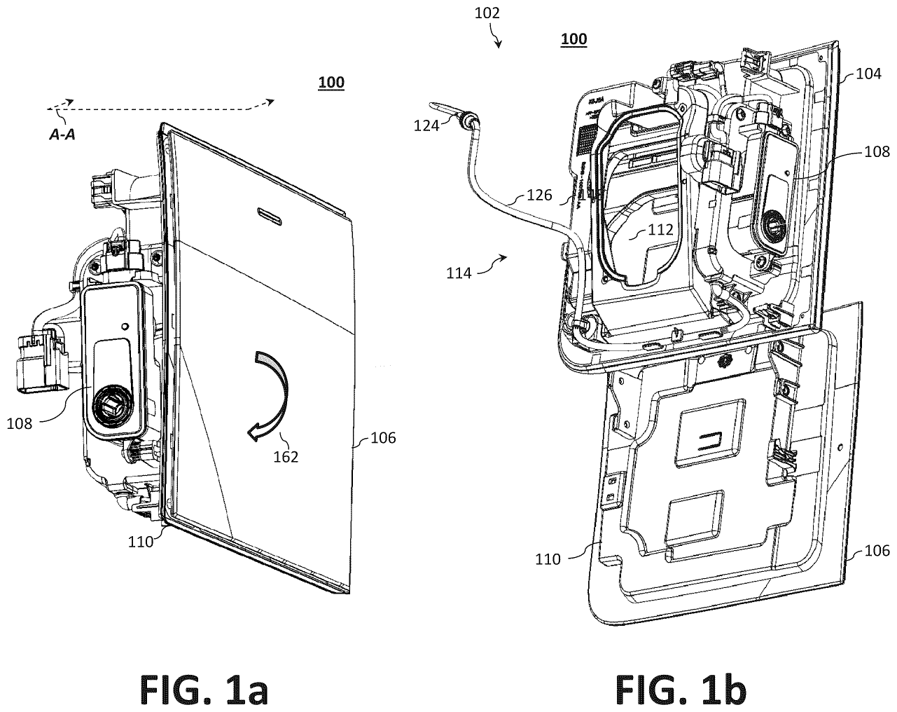

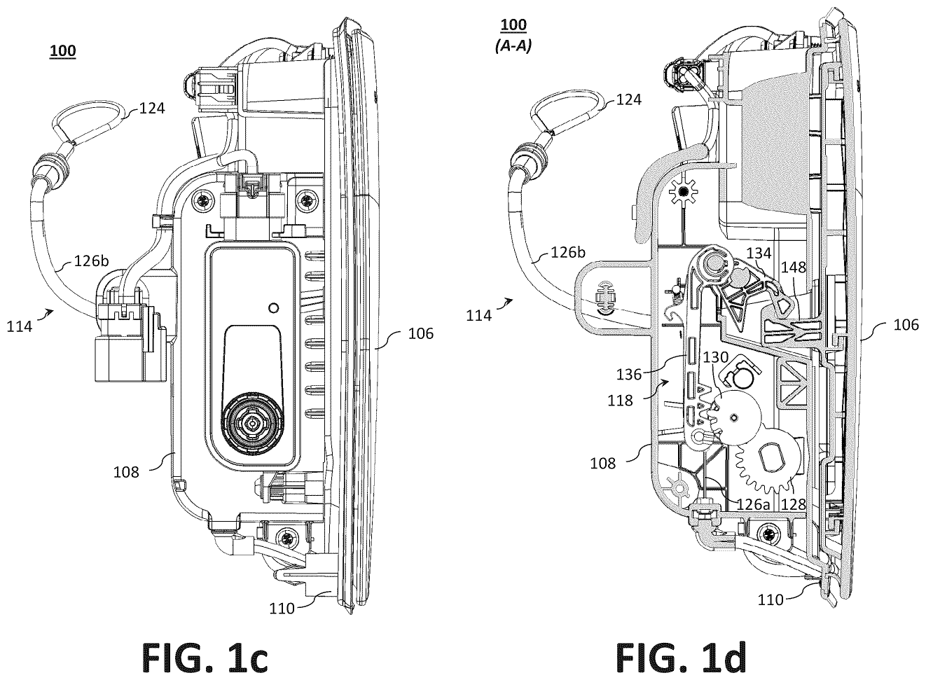

FIGS. 1a and 1b illustrate, respectively, perspective views of an actuating assembly 100 in accordance with an aspect of the subject disclosure in closed and open positions. FIG. 1c provides a side view of the actuating assembly 100 in the closed position, while FIG. 1d depicts a cross-sectional side view of the actuating assembly 100 along cut line A-A.

The actuating assembly 100 generally comprises a cover assembly 102, a housing 104, and a drive assembly 108. The cover assembly 102 is shown here as a charging flap assembly (but the subject disclosure would also be appliable to fuel doors and other flaps/doors). In this example, the cover assembly 102 comprises a cover 106, and a cover frame 110. The cover assembly 102 is configured to selectively cover a charging/fueling compartment 112. The cover frame 110 offers rigidity, structure, and operational features to the cover assembly 102, while the cover 106 provides a decorative element/cover that matches the surrounding vehicle aesthetics, while covering the charging/fueling compartment 112. For example, the cover frame 110 may provide functional components such as a locking element 148 or hinges, whereas the cover 106 may be styled to blend with the vehicle's appearance.

The actuating assembly 100 is configured to perform several functions. First, it moves the cover assembly 102 between open and closed positions. Second, it locks the cover assembly 102 in the closed position. The actuating assembly 100 also features overriding and/or ice-breaking functionality via, for example, an override assembly 114 that is configured to mitigate ice accumulation that could hinder the movement of the cover assembly 102.

The drive assembly 108 controls both the position (e.g., between open and closed positions) and the locking status (e.g., a locked state or an unlocked state) of the cover assembly 102. In some examples, the drive assembly 108 may be electrically powered and can include an electric motor with a drive shaft 116 configured to generate and/or otherwise output a rotational force. The drive assembly 108 drives the cover assembly 102 through a drive train 118, which includes a cover linkage assembly 120 and a gear assembly 122 operably connected to the cover linkage assembly 120. The rotational force from the drive assembly 108 is transmitted through the drive shaft 116 and gear assembly 122 to the cover linkage assembly 120, effectuating the movement of the cover assembly 102.

In the illustrated example, the actuating assembly 100 incorporates a manually-operable override assembly 114. The override assembly 114 is configured to allow the user to manually drive or dislodge the drive assembly 108 or components thereof (e.g., the drive train 118) in the event of an obstruction or failure. For example, if ice buildup renders the actuating assembly 100 inoperative, the user can manually engage the override assembly 114 to break through the ice and enable the cover 106 to move to the open position in the direction as indicated by arrow 162. Similarly, a user can manually engage the override assembly 114 to move the cover 106 to the open position in the event of power failure.

In the illustrated example, the override assembly 114 includes a handle 124, depicted as a pull loop, connected to the drive assembly 108 via, for example, a cable 126. The illustrated cable 126 comprises an inner wire 126a that is configured to move within an outer sheath 126b. For example, the cable 126 may be a Bowden cable that is configured to transmit mechanical force by allowing the inner wire 126a to slide relative to the outer sheath 126b to push or pull a component. The handle 124 can be positioned within a use-accessible part of the vehicle, such as the trunk or engine bay, adjacent to the actuating assembly 100. This configuration enables the operator to manually unlock the actuating assembly 100 and release the cover assembly 102 in the event of power failure, mechanical malfunction, or adverse weather conditions (e.g., ice build up).

The outer sheath 126b of the cable may feature a composite construction, including an inner lining, a longitudinally incompressible layer (e.g., a helical winding or steel wire sheath), and a protective outer covering. This construction allows the cable 126 to effectively transmit manual force from the handle 124, enabling the user to dislodge the drive train 118 and overcome ice accumulation, thereby restoring the function of the actuating assembly 100 and allowing the cover 106 to open.

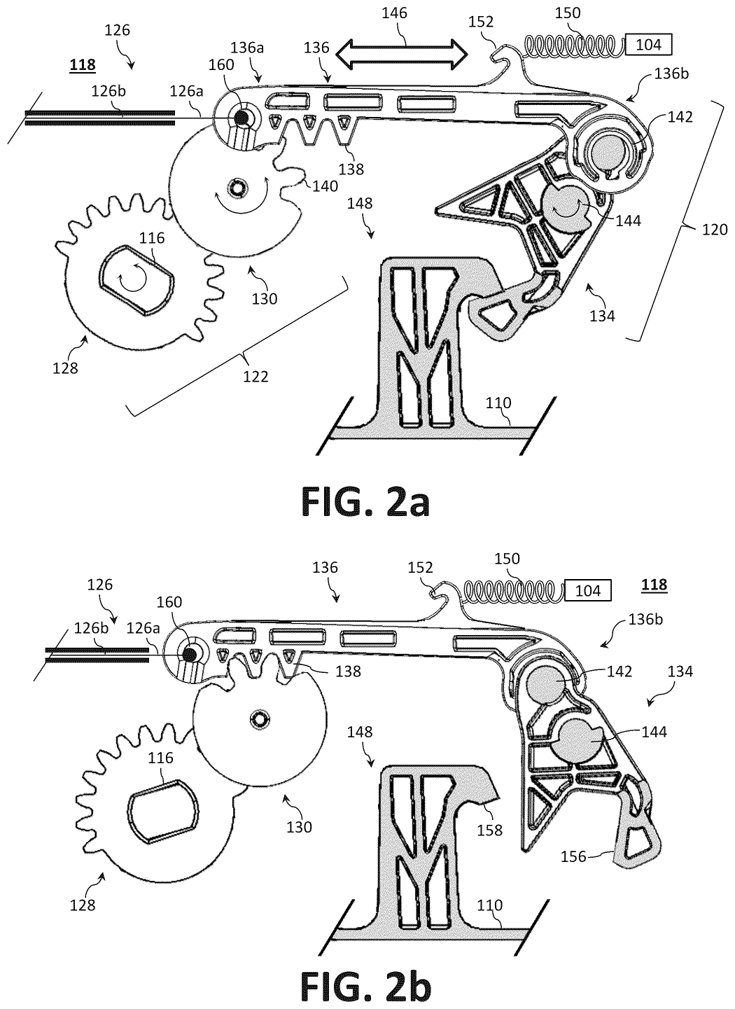

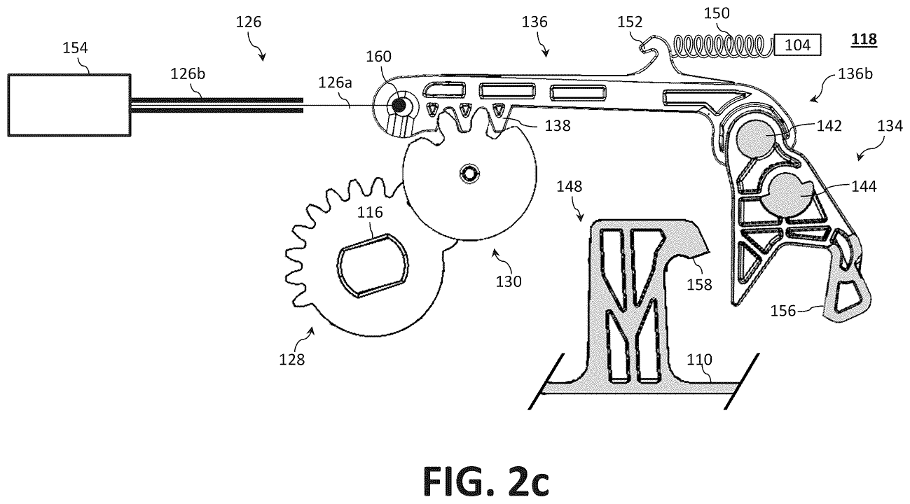

FIGS. 2a and 2b illustrate detailed, schematic views of an example drive train 118, showing the gear assembly 122 in locked and unlocked states, respectively. Various components are omitted in these views for clarity. The illustrated drive train 118 includes the gear assembly 122 and the cover linkage assembly 120. The gear assembly 122 comprises a drive pinion 128 and a cam pinion 130, while the cover linkage assembly 120 includes a flap lock 134 and a gear-rack cam 136.

The drive pinion 128 is fixedly attached to the drive shaft 116, and it engages with the cam pinion 130 through meshing gear teeth. In some configurations, the drive pinion 128 and the cam pinion 130 may include end stops to limit their rotational angles, which can restrict the movement of the flap lock 134 or the cover assembly 102.

The cam pinion 130 meshes with the gear-rack cam 136 at its first end 136a. Teeth 138 on the first end 136a of the gear-rack cam 136 engage with teeth 140 on the drive pinion 128. A resilient abutment bearing may be provided to maintain constant contact between the teeth 138 of the gear-rack cam 136 and the teeth 140 of the drive pinion 128. This resilient abutment, which could be a spring or similar mechanism, biases the first end 136a toward the cam pinion 130.

The flap lock 134 is pivotally connected to the second end 136b of the gear-rack cam 136 via a pivot connection 142. The flap lock 134 pivots about axis 144 relative to the housing 104. When the drive shaft 116 rotates the drive pinion 128, the cam pinion 130 also rotates, engaging the gear-rack cam 136 and causing it to translate as indicated by arrow 146. This movement of the gear-rack cam 136 pivots the flap lock 134 between its locked state (FIG. 2a) and unlocked state (FIG. 2b). In the locked state, the flap lock 134 engages with a locking element 148 on the cover frame 110, securing the cover assembly 102 in place. In the unlocked state, the flap lock 134 disengages from the locking element 148, allowing the cover assembly 102 to move freely. Accordingly, the locking hook 134 has an undercut 156, which operatively engages with a corresponding undercut 158 of the locking element 148 when the cover assembly 102 is locked in its closed position.

A biasing element 150, such as a spring, a elastic band, a linear actuator, etc., may be connected between the housing 104 and the gear-rack cam 136 via a hook 152 to bias the gear assembly 122 into a default locked position. In this default position (shown in FIG. 2a), the biasing element 150 maintains the flap lock 134 in the locked position, preventing the cover 106 from being opened without damaging the flap lock 134. Alternatively, the flap lock 134 can be configured to allow the cover to be opened without damage, even when locked.

In the locked state, the flap lock 134 secures the cover 106 by engaging with a locking element 148 formed in or on the cover frame 110. To unlock the cover assembly 102, the drive pinion 128 rotates clockwise, driving the cam pinion 130 counterclockwise. This movement pulls the gear-rack cam 136, causing the flap lock 134 to rotate and disengage from the locking element 148, releasing the cover assembly 102 for movement. The override assembly 114 operates by pulling the wire 126a, which is fixedly coupled via its distal end 160 to the first end 136a of the gear-rack cam 136. This action opposes the force applied by the biasing element 150, manually pivoting the flap lock 134 about axis 144 into the unlocked state.

While the override assembly 114 is described as a manual mechanism (e.g., using a handle 124), a powered override actuator 154 may also be employed. FIG. 2c provides a detailed view of the actuating assembly having a powered override actuator in accordance with another aspect of the present disclosure.

The powered override actuator 154, which could be electrically, pneumatically, or hydraulically controlled, can be used to pull the wire 126a, either in addition to or instead of the handle 124. In scenarios where ice accumulation obstructs the drive shaft 116 or the electric motor, the powered override actuator 154 can provide the necessary force to break through the obstruction or ice build up. The powered override actuator 154 may be located in a protected area (e.g., protected from the elements) of the vehicle, such as the trunk, to ensure reliability. Additionally, the actuating assembly 100 may include a pushing element that helps release the cover assembly 102 if it becomes stuck, for example, due to icing. For example, a powered override actuator 154 can be configured to pull the second end 136b of the gear-rack cam 136 via a cable 126 or portion thereof (e.g., the wire 166a) in response to a control signal to thereby move the flap lock 134 from the locked state to the unlocked state.

In one example, the drive train 118 operates utilizing an electric motor to rotate the drive pinion 128, which transfers motion to the gear-rack cam 136 through the cam pinion 130. The cam pinion 130 may be composed of two portions: a cam gear portion and a motor drive gear portion. The cam gear portion and the motor drive gear portion can either be integrated as a single unitary structure or assembled as two separate components sharing a common axis of rotation.

When the drive pinion 128 engages the cam gear portion of the cam pinion 130, the motor drive gear portion may rotates in a 1:1.5 gear ratio. Specifically, the motor drive gear rotates the drive pinion 128 by 137 degrees after an initial 21.5-degree rotation to move the latching system. The cam pinion 130 then rotates 78 degrees along the gear-rack cam 136, remaining engaged through spring force until reaching a total rotation of 226.5 degrees. This movement pulls down the flap lock 134 by 21.5 degrees to unlatch the cover assembly 102, followed by an additional 78-degree rotation of the flap lock and gear-rack cam.

The override assembly 114 is activated by pulling a cable cord, which transmits force to the gear-rack cam 136 near the motor. This action pulls the gear-rack cam 136 downward, causing the cam pinion 130 to rotate and initiating the motor's movement to begin opening the cover assembly 102. As the gear-rack cam 136 moves downward, it also pulls on the flap lock 134, unlatching the cover assembly 102. Once unlatched, the user can manually push down on the cover assembly 102 to fully open it. The gear-rack cam 136 only needs to move enough to start motor movement, allowing the top of the cover assembly 102 to be exposed for manual operation. The override assembly 114, serving as an electronic release (e-release), is connected directly on the gear-rack cam 136, as it controls the latching system and coordinates the movement of both the motor and flap lock 134 to release the cover assembly 102.

The above-cited patents and patent publications are hereby incorporated by reference in their entirety. While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A drive assembly to move a cover assembly of a vehicle relative to a housing between an open position and a closed position, the drive assembly comprising:
a drive pinion configured to receive a drive shaft;
a cam pinion meshed with the drive pinion, wherein the drive pinion is configured to rotate the cam pinion;
a gear-rack cam having a first end and a second end,
wherein the second end is meshed with the cam pinion, and
wherein the gear-rack cam is configured to translate in response to rotation of the cam pinion; and
a flap lock configured to pivot relative to the housing between a locked state and an unlocked state,
wherein the flap lock is pivotally connected to the second end of the gear-rack cam via a pivot connection; and
an override assembly operably coupled to the second end of the gear-rack cam and configured to translate the gear-rack cam to move the flap lock from the locked state to the unlocked state.

2. The drive assembly of claim 1, wherein the override assembly comprises a handle and a cable, wherein the cable is coupled to the handle and to the second end of the gear-rack cam.

3. The drive assembly of claim 2, wherein manipulation of the handle actuates the cable to move the flap lock from the closed position to the open position.

4. The drive assembly of claim 2, wherein the cable comprises a wire and an outer sheath, the wire being slidable within the outer sheath to transmit force between the handle and the second end of the gear-rack cam.

5. The drive assembly of claim 1, further comprising a powered override actuator configured to pull the second end of the gear-rack cam via a cable or portion thereof in response to a control signal to thereby move the flap lock from the locked state to the unlocked state.

6. The drive assembly of claim 5, wherein the powered override actuator includes an electric motor.

7. An actuating assembly for a cover assembly of a vehicle, the actuating assembly comprising:
a housing having a compartment;
a drive assembly coupled to the housing,
wherein the drive assembly comprises a drive train that is configured to move the cover assembly relative to the housing between an open position and a closed position, and
wherein the drive assembly is configured to secure the cover assembly in a locked state to cover the compartment; and
an override assembly operably coupled to the drive train and configured to move the cover assembly from the locked state to an unlocked state.

8. The actuating assembly of claim 7, wherein the override assembly comprises a handle and a cable, wherein the cable is coupled between the handle and the drive train.

9. The actuating assembly of claim 8, wherein the handle is a pull loop.

10. The actuating assembly of claim 8, wherein manipulation of the handle actuates the cable to allow the cover assembly to move from the closed position to the open position.

11. The actuating assembly of claim 8, wherein the cable comprises a wire and an outer sheath, the wire being slidable within the outer sheath to transmit force between the handle and the drive train.

12. The actuating assembly of claim 11, wherein the outer sheath comprises: an inner lining; a longitudinally incompressible layer; and a protective outer covering.

13. The actuating assembly of claim 7, wherein the drive train comprises a cover linkage assembly that is configured to secure the cover assembly in the locked state and a gear assembly that is operably connected to the cover linkage assembly.

14. The actuating assembly of claim 13, wherein the gear assembly comprises: a drive pinion configured to receive a drive shaft; and a cam pinion meshed with the drive pinion.

15. The actuating assembly of claim 14, wherein the cover linkage assembly comprises a flap lock and a gear-rack cam having a first end and a second end, wherein the flap lock is pivotally connected to the second end of the gear-rack cam via a pivot connection and is configured to pivot about an axis relative to the housing.

16. The actuating assembly of claim 15, wherein the gear-rack cam is configured to mesh with the cam pinion, the gear-rack cam being configured to translate in response to rotation of the cam pinion.

17. The actuating assembly of claim 16, wherein the flap lock is configured to pivot about an axis in response to translation of the gear-rack cam, the flap lock moving between the locked state and the unlocked state.

18. The actuating assembly of claim 7, further comprising a powered override actuator configured to pull the cable or portion thereof in response to a control signal, thereby disengaging the locking mechanism and allowing the cover assembly to move to the open position.

19. The actuating assembly of claim 18, wherein the powered override actuator includes an electric motor.

20. The actuating assembly of claim 12, wherein the compartment is: a charging compartment; a fueling compartment; or a service compartment of the vehicle.
